(19) United States
(12) Patent Application Publication
(10) Pub. No.: US 2013/0293130 A1
(43) Pub. Date: Nov. 7, 2013

(54) High Efficiency 3-Way Halogen Lamp With Diode and Sidac Driven Single Filament Lamp

(71) Applicants: Ernest C. Weyhrauch, Richmond, KY (US); James E. Oetken, Winchester, KY (US); George B. Kendrick, Lexington, KY (US)

(72) Inventors: Ernest C. Weyhrauch, Richmond, KY (US); James E. Oetken, Winchester, KY (US); George B. Kendrick, Lexington, KY (US)

(73) Assignee: OSRAM SYLVANIA INC., Danvers, MA (US)

(21) Appl. No.: 13/463,955

(22) Filed: May 4, 2012

(51) Int. Cl. H05B 37/02

(52) U.S. Cl. 315/200 R

(57) ABSTRACT

A 3-way halogen lamp selectively generates different first, second, and third light levels. A first terminal on the lamp base receives a first input voltage waveform when the first terminal is connected to a power source. A second terminal on the lamp base receives a second input voltage waveform when the second terminal is connected to the power source. A rectifier circuit is connected to the first terminal for receiving the first input voltage waveform and rectifying the first input voltage waveform to generate a first load voltage waveform. A switching circuit is connected to the second terminal for receiving the second input voltage waveform and phase clipping the second input voltage waveform to generate a second load voltage waveform. A single filament is connected to the rectifier circuit and the switching circuit, and is housed in a halogen capsule attached to the lamp base.

### BACKGROUND

The disclosure relates to a 3-way lamp that generates different first, second, and third light levels with a single filament halogen capsule.

### PRIOR ART

A standard 3-way lamp is configured to selectively generate three light levels (e.g., a low light level, a mid light level, and a high light level) when it is used in a 3-way lamp fixture. The standard 3-way lamp is typically marketed by wattage levels. For example, a 3-way incandescent lamp may be marketed as operating at a 30 Watt/305 lumen level, a 70 Watt/995 lumen level, and a 100 Watt/1300 lumen level. In contrast to a lamp fixture having a socket with two terminals for energizing a lamp at one, single light level, a 3-way lamp fixture has a specifically designed socket (“3-way socket”) with three terminals. The three terminals include two power supply terminals (i.e., first power supply terminal and second power supply terminal) and a neutral terminal. Accordingly, a standard 3-way lamp has a base with three input terminals for connecting with each of the three terminals of the 3-way socket.

In order to achieve three different light levels, the standard 3-way lamp has two filaments. One filament is connected to the first power supply terminal and is designed to operate at the low wattage rating. The other filament is connected to the second power supply terminal and is designed to operate at the mid wattage rating. During the low level light operation, power is supplied only to the first power supply terminal of the two power supply terminals. And, thus, only the first filament of the two filaments produces light. During the mid level light operation, power is supplied only to the second power supply terminal of the two power supply terminals. And, thus, only the second filament of the two filaments produces light. During the high level light operation, power is supplied to both the first and second power supply terminals, and thus, the first and second filaments both produce light. This design and operation of a standard incandescent 3-way lamp using two filaments is described in U.S. Pat. No. 5,239,233.

The design and operation of a 3-way halogen lamp having two filaments is described in U.S. Pat. No. 6,919,684. However, placing two filaments in a halogen capsule, such as a 120 Volt halogen capsule, makes it highly likely that the filaments will come in contact with each other due to shock or vibration. U.S. Pat. No. 4,654,560 discloses a halogen lamp with two filaments, a tungsten filament and a ballast filament. The ballast filament is used to limit the current to the tungsten filament. This arrangement is not energy efficient.

The following are also know in the prior art: U.S. Pat. No. 6,445,133 (Lin et al), U.S. Pat. No. 5,356,314 (Aota), U.S. Pat. No. 7,166,964 (Weyhrauch et al), U.S. Pat. No. 3,836,814 (Rodriquez), and US Patent Application Publication No. 2005/0110438 (Ballenger, Weyhrauch).

### SUMMARY

In one embodiment, a single filament halogen lamp provides three lighting levels. In particular, the lamp includes a base having a first lamp terminal and a second lamp terminal that are each configured for selectively connecting to a power source. When the first lamp terminal is connected to the power source, the first lamp terminal receives a first input voltage waveform from the power source. When the second lamp terminal is connected to the power source, the second lamp terminal receives a second input voltage waveform from the power source.

A rectifier circuit is connected to the first lamp terminal for receiving the first input voltage waveform from the first lamp terminal. The rectifier circuit rectifies the first input voltage waveform to generate a first load voltage waveform. A switching circuit is connected to the second lamp terminal for receiving the second input voltage waveform from the second lamp terminal. The switching circuit phase clips the second input voltage waveform to generate a second load voltage waveform.

A halogen capsule is attached to the base of the lamp, and a single filament is housed within the halogen capsule. The single filament is connected to the rectifier circuit and to the switching circuit. When only the first lamp terminal of the first and second lamp terminals is connected to the power source, the single filament receives only the first load voltage waveform of the first and second load voltage waveforms and generates a first light level (e.g., low light level) therefrom. When only the second lamp terminal of the first and second lamp terminals is connected to the power source, the single filament receives only the second load voltage waveform of the first and second load voltage waveforms and generates a second light level (e.g., mid light level) therefrom. When the first and second lamp terminals are both connected to the power source, the single filament receives, both, the first and second load voltage waveforms and generates a third light level (e.g., high light level) therefrom.

Other objects and features will be apparent and pointed out hereinafter.

### BRIEF DESCRIPTION OF THE DRAWINGS

FIG. 1 is a cross section of a single filament, 3-way lamp in accordance with one embodiment.

FIG. 2 is a cross section of a single filament, 3-way lamp in accordance with one embodiment.

FIG. 3 is a circuit diagram of a voltage conversion circuit for use in a single filament, 3-way lamp in accordance with one embodiment.

FIG. 4 A is an input waveform received by the voltage conversion circuit of FIG. 3 in accordance with one embodiment.

FIG. 4B is an output waveform generated by the voltage conversion circuit of FIG. 3 in accordance with one embodiment.

FIG. 5 A is an input waveform received by the voltage conversion circuit of FIG. 3 in accordance with one embodiment.

FIG. 5B is an output waveform generated by the voltage conversion circuit of FIG. 3 in accordance with one embodiment.

FIG. 6 is an output waveform generated by the voltage conversion circuit of FIG. 3 in accordance with one embodiment.

Corresponding reference characters indicate corresponding parts throughout the drawings.

### DETAILED DESCRIPTION

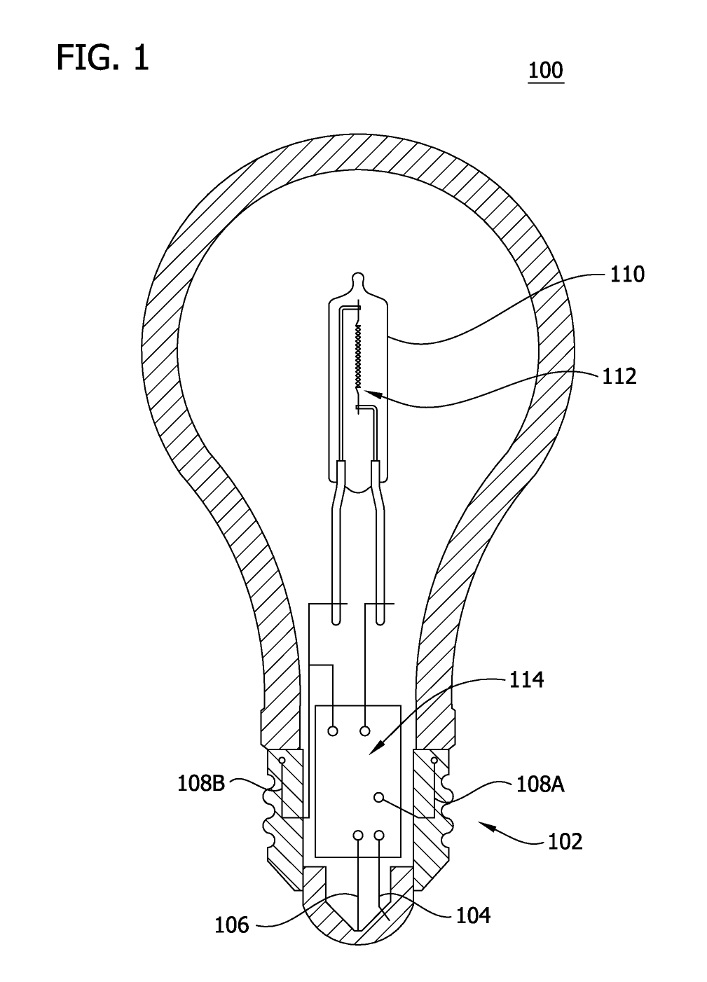

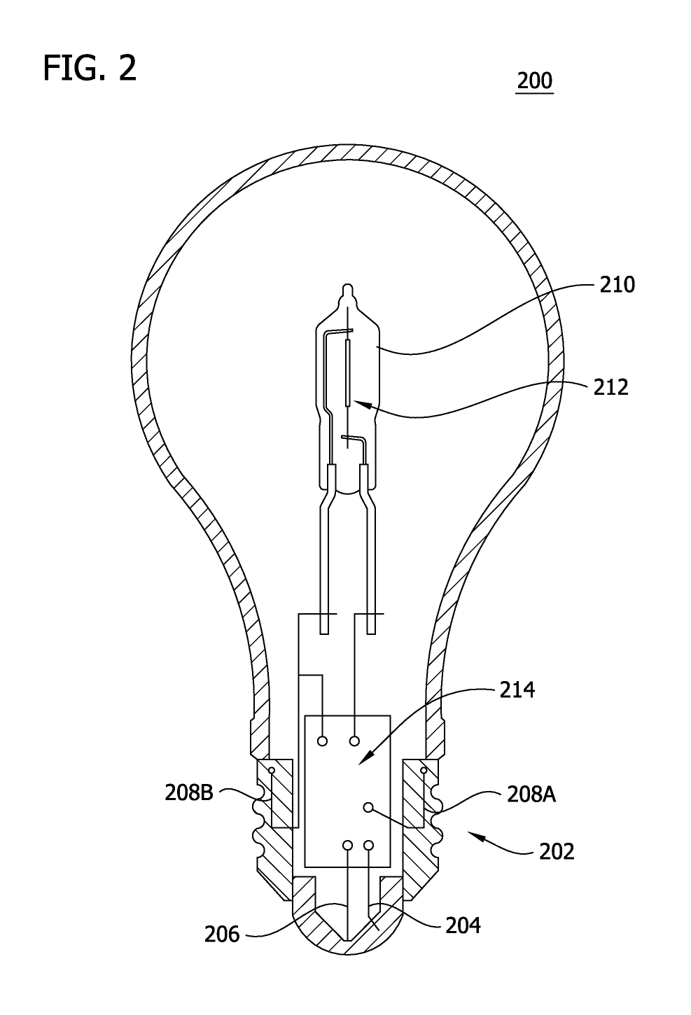

FIGS. 1 and 2 each illustrate an exemplary single filament, 3-way lamp 100, 200 in accordance with one embodiment. The lamp 100, 200 is configured to be used with a 3-way lamp fixture in order to generate a first light level, a second light level, and a third light level. In particular, the lamp includes a base 102, 202 that is arranged and adapted to fit into a lamp socket of a 3-way lamp fixture. The base 102, 202 has three lamp input terminals: a first lamp input terminal 104, 204, a second lamp input terminal 106, 206, and a third lamp input terminal 108A, 108B, 208A, 208B. The first lamp input terminal 104, 204 and the second lamp input terminal 106, 206 are each configured for selectively connecting to a power source via the 3-way lamp fixture. The third lamp input terminal 108A, 108B, 208A, 208B is configured for connecting to a neutral potential.

In the illustrated embodiment, the first lamp input terminal 104, 204 and the second lamp input terminal 106, 206 are located on a bottom surface of the base 102, 202 for interfacing with the lamp socket. In one embodiment, the first lamp input terminal 104, 204 (e.g., base ring terminal) is a ring-shaped contact that is positioned off-center on the bottom surface of the base 102, 202. The second lamp input terminal 106, 206 (e.g., base eyelet terminal) is a contact that is generally positioned in the center of the bottom surface of the base 102, 202. Although the first lamp input terminal 104, 204 and the second lamp terminal are illustrated as the base ring terminal and the base eyelet terminal, respectively, it should be noted that the first lamp input terminal 104, 204 may be the base eyelet terminal and the second lamp input terminal 106, 206 may be the base ring terminal. The first lamp input terminal 104, 204 and the second lamp input terminal 106, 206 are configured for connecting to an alternating current (“AC”) line voltage, such as 120 Volts, and receiving an input voltage waveform therefrom. The base 102, 202 of the lamp includes a threaded metal shell for securing the base 102, 202 into the lamp socket. The threaded metal shell forms the third lamp input terminal 108A, 108B, 208A, 208B (e.g., neutral terminal).

A light emitting envelope is attached to the base 102, 202 and houses a light emitting element. In particular, the light emitting envelope is a halogen capsule 110, 210 and the light emitting element is a single filament 112, 212 housed within the halogen capsule 110, 210. For example, as shown in FIG. 1, the lamp 100 may be an A-Line heavy-wall lamp, such as the Sylvania Capsylite A19 halogen light bulb. Alternatively, as shown in FIG. 2, the lamp 200 may be an A-Line thin-wall lamp, such as the Sylvania HALOGEN Supersaver® light bulb. It should be noted that the scope includes other single filament halogen capsule lamps and is not limited to the illustrated embodiments.

The lamp 100, 200 includes a voltage conversion circuit (illustrated generally in FIGS. 1 and 2 as 114 and 214, respectively) connected between the lamp input terminals 104, 106, 204, 206 and the single filament 112, 212. The voltage conversion circuit 114, 214 is configured to reduce the input voltage waveform(s) received via the lamp input terminals 104, 106, 204, 206 in order to generate three voltage levels for operating the single filament 112, 212. The single filament 112, 212, in turn, is able to produce three different light levels. In one embodiment, when the first lamp input terminal 104, 204 is connected to the power source (e.g., AC line voltage), the first lamp input terminal 104, 204 receives a first input voltage waveform having a first RMS initial voltage. The voltage conversion circuit 114, 214 converts the first input voltage waveform to a first load voltage waveform having a first RMS load voltage. In particular, the voltage conversion circuit 114, 214 reduces RMS voltage of the first input voltage waveform so that the first RMS load voltage is less than the first RMS initial voltage. Similarly, when the second lamp input terminal 106, 206 is connected to the power source (e.g., AC line voltage), the second lamp input terminal 106, 206 receives a second lamp input voltage waveform having a second RMS initial voltage. The voltage conversion circuit 114, 214 converts the second input voltage waveform to a second load voltage waveform having a second RMS load voltage. In particular, the voltage conversion circuit 114, 214 reduces RMS voltage of the second input voltage waveform so that the second RMS load voltage is less than the second RMS initial voltage.

Accordingly, the lamp 100, 200 is operated between the three different light levels by selectively connecting the first lamp input terminal 104, 204 to the power source and selectively connecting the second lamp input terminal 106, 206 to the power source. In particular, when only the first lamp input terminal 104, 204 of the first and second lamp input terminals 104, 106, 204, 206 is connected to the power source, the only input voltage waveform received by the voltage conversion circuit 114, 214 is the first input voltage waveform. As discussed above, the voltage conversion circuit 114, 214 converts the first input voltage waveform to produce the first load voltage waveform having the first RMS load voltage. The first load voltage waveform is provided to the single filament 112, 212 which generates a first light level from the first load voltage waveform. Similarly, when only the second lamp input terminal of the first and second lamp input terminals 104, 106, 204, 206 is connected to the power source, the only input voltage waveform received by the voltage conversion circuit 114, 116 is the second input voltage waveform. As discussed above, the voltage conversion circuit 114, 116 converts the second input voltage waveform to produce the second load voltage waveform having the second RMS load voltage. The second load voltage waveform is provided to the single filament 112, 212 which generates a second light level from the second load voltage waveform. When the first and the second lamp input terminals 104, 106, 204, 206 are simultaneously connected to the power source, the first and the second input voltage waveforms are both received by the voltage conversion circuit 114, 116. The voltage conversion circuit 114, 116 produces a third load voltage waveform having a third RMS load voltage as a function of the first and second input voltage waveforms. The third load voltage waveform is provided to the single filament 112, 212 which generates a third light level from the third load voltage waveform.

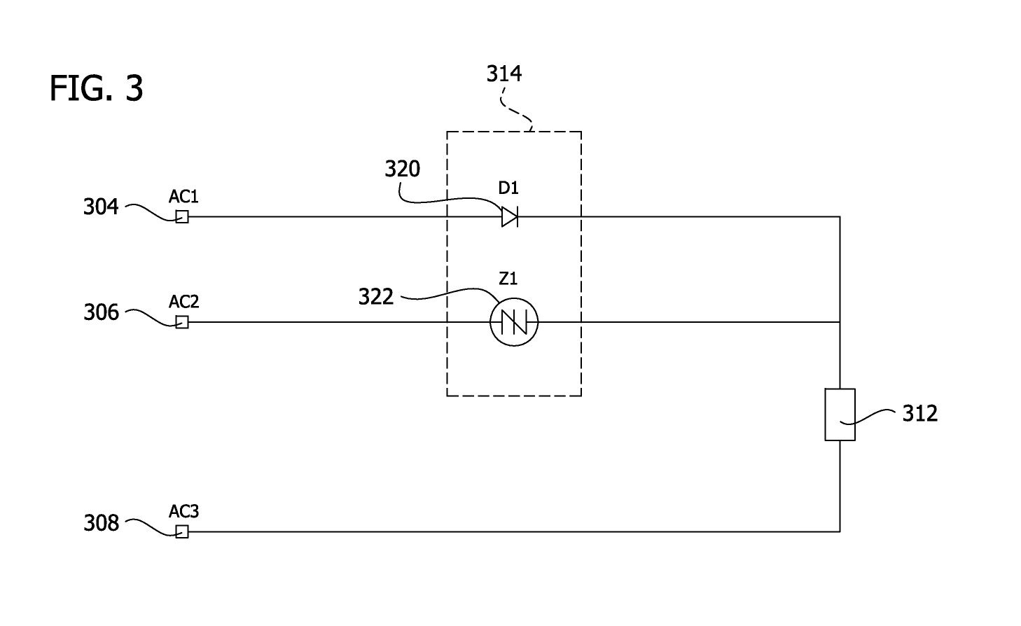

Referring to FIG. 3, in one embodiment, the voltage conversion circuit 314 includes a rectifier circuit 320 and a switching circuit 322. The rectifier circuit 320 is connected between the first lamp input terminal 304 and the single filament 312, and in series with the first lamp input terminal 304 and the single filament 312. In operation, the rectifier circuit 320 receives the first input voltage waveform having the first RMS initial voltage via the first lamp input terminal 304. The rectifier circuit 320 rectifies the first input voltage waveform to generate the first load voltage waveform having the first RMS load voltage. The switching circuit 322 is connected between the second lamp input terminal 306 and the single filament 312, and in series with the second lamp input terminal 306 and the single filament 312. In operation, the switching circuit 322 receives the second input voltage waveform having the second RMS initial voltage via the second lamp input terminal 306. The switching circuit 322 phase clips the second input voltage waveform to generate the second load voltage waveform having the second RMS load voltage.

As illustrated, the rectifier circuit 320 and the switching circuit 322 are connected to the lamp input terminals 304 and 306 such that the rectifier circuit 320 only receives an input voltage waveform when the first lamp input terminal 304 is connected to the power source, and the switching circuit 322 only receives an input voltage waveform when the second lamp input terminal 306 is connected to the power source. Accordingly, when only the first lamp input terminal 304 of the first and second lamp input terminals 304, 306 is connected to the power source, only the rectifier circuit 320 receives an input voltage waveform (i.e., first input voltage waveform), and the only load voltage waveform received by the single filament 312 is the first load voltage waveform produced by the rectifier circuit 320. Thus, the single filament 312 generates a first light level as a function of the first load voltage waveform. When only the second lamp input terminal 306 of the first and second lamp input terminals 304, 306 is connected to the power source, only the switching circuit 322 receives an input voltage waveform (i.e., second input voltage waveform), and the only load voltage waveform received by the single filament 312 is the second load voltage waveform produced by the switching circuit 322. Thus, the single filament 312 generates a second light level as a function of the second load voltage waveform. When both the first and the second lamp input terminals 304, 306 are connected to the power source, the rectifier circuit 320 and the switching circuit 322 both receive input voltage waveforms. In particular, the rectifier circuit 320 receives the first input voltage waveform via the first lamp input terminal 304 and the switching circuit 322 receives the second input voltage waveform via the second lamp input terminal 306. The first load voltage waveform produced by the rectifier circuit 320 and the second load voltage waveform produced by the switching circuit 322 are combined to form a third load voltage waveform which is received by the single filament 312. Thus, the single filament 312 generates a third light level as a function of the first load voltage waveform and the second load voltage waveform.

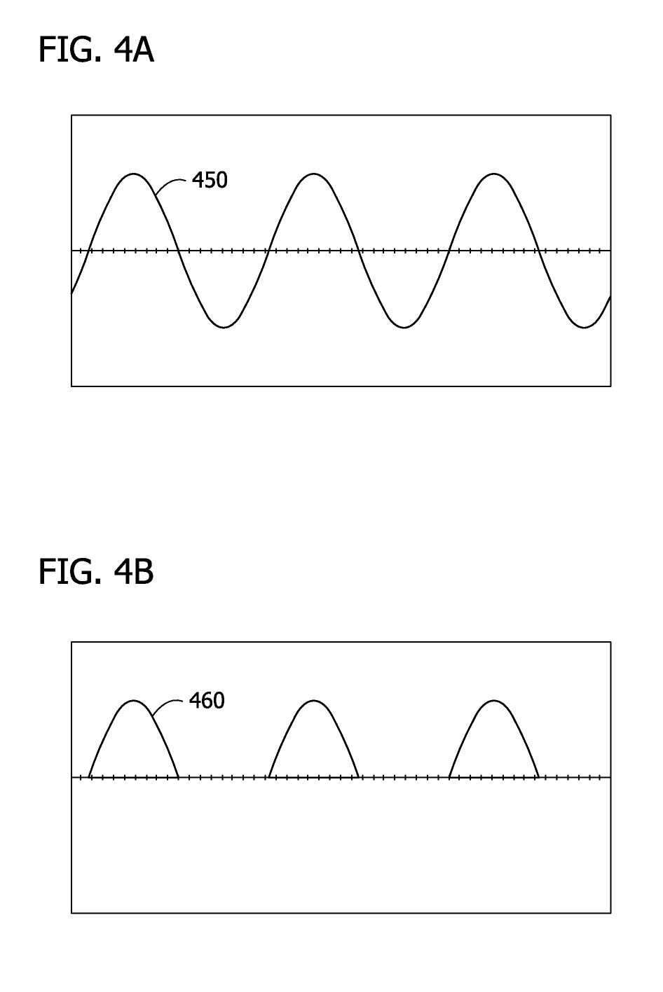

In the embodiment illustrated in FIG. 3, the rectifier circuit 320 is a half-wave rectifier, such as a diode D1. For example, the diode D1 may be a 1N4935 diode manufactured by Diodes Incorporated. As generally known, the diode D1 has an anode and a cathode. The anode of the diode D1 is connected to the first lamp input terminal 304, and the cathode of the diode D1 is connected to the single filament 312. In operation, the diode D1 receives the first input voltage waveform via the first lamp input terminal 304. FIG. 4A illustrates an exemplary first input voltage waveform 450 received by the diode D1 via the first lamp input terminal 304. The exemplary first input voltage waveform 450 has an RMS voltage (e.g., “first RMS initial voltage”) of about 120 Volts. The diode D1 half wave rectifies the first input voltage waveform 450 to generate the first load voltage waveform. FIG. 4B illustrates an exemplary first load voltage waveform 460 produced by the diode D1 by half-wave rectifying the first input voltage waveform 450 illustrated in FIG. 4A. The exemplary first load voltage waveform 460 has an RMS voltage (e.g., “first RMS load voltage”) of about 84 Volts.

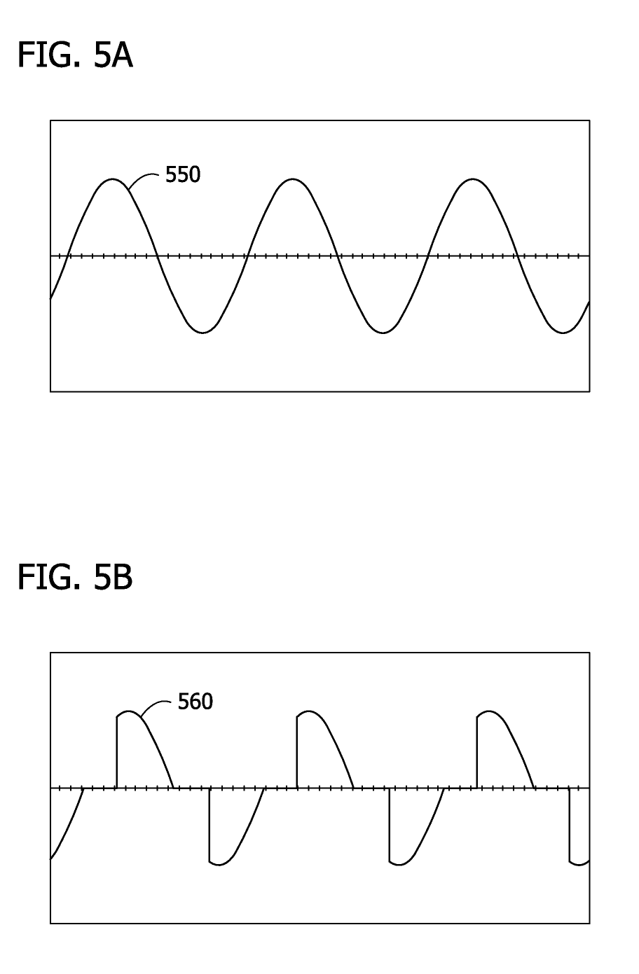

In the embodiment illustrated in FIG. 3, the switching circuit 322 is a silicon diode for alternating current (SIDAC), indicated at Z1. For example, the SIDAC Z1 may be an MKP1V160 SIDAC manufactured by ON Semiconductor®. The SIDAC Z1 is a high voltage bilateral trigger switch that switches from a blocking state to a conducting state when the applied voltage of either polarity exceeds a predetermined breakover voltage. For example, in one embodiment the SIDAC Z1 may have a breakover voltage of 160V. The SIDAC Z1 remains in the conducting state until the applied voltage reaches zero. In operation, the SIDAC Z1 receives the second input voltage waveform via the second lamp input terminal 306. FIG. 5A illustrates an exemplary second input voltage waveform 550 received by the SIDAC Z1 via the second lamp input terminal 306. The exemplary second input voltage waveform 550 has an RMS voltage (e.g., “second RMS initial voltage”) of about 120 Volts. The SIDAC Z1 blocks voltage of the second input voltage waveform 550 until the amplitude of the second input waveform reaches the breakover voltage (e.g., 160V). The SIDAC Z1 then operates in a conductive state until the second input voltage waveform 550 has an amplitude equal to zero. The SIDAC Z1 continues to operate in between the blocking and conductive states as described herein while the second lamp input terminal 306 is receiving the second input voltage waveform 550 from the power source. FIG. 5B illustrates an exemplary second load voltage waveform 560 produced by the SIDAC Z1 accordingly from the second input voltage waveform 550 illustrated in FIG. 5A. The exemplary second load voltage waveform 560 has an RMS voltage (e.g., “second RMS load voltage”) of about 100 Volts.

Referring to FIGS. 3, 4A, 4B, 5A, and 5B, when only the first lamp input terminal 304 of the first and second lamp input terminals 304, 306 is connected to the power source, the only input voltage waveform received by the voltage conversion circuit 314 is the first input voltage waveform 450 (see FIG. 4A). The diode D1 half-wave rectifies the first input voltage waveform 450 to generate the first load voltage waveform 460 (see FIG. 4B). The single filament 312 is then energized exclusively as a function of the first load voltage waveform. As such, the single filament 312 produces a first light level that corresponds to the first RMS load voltage. On the other hand, when only the second lamp input terminal 306 of the first and second lamp input terminals 304, 306 is connected to the power source, the only input voltage waveform received by the voltage conversion circuit 314 is the second input voltage waveform 550 (see FIG. 5A). The SIDAC Z1 voltage clips the second input voltage waveform 550 to generate the second load voltage waveform 560 (see FIG. 5B). The single filament 312 is then energized exclusively as a function of the second load voltage waveform. As such, the single filament 312 produces a second light level that corresponds to the second RMS load voltage. According to the illustrated embodiment, the second RMS load voltage is greater than the first RMS load voltage, so the second light level is brighter (i.e., has a greater light intensity, more lumens) than the first light level.

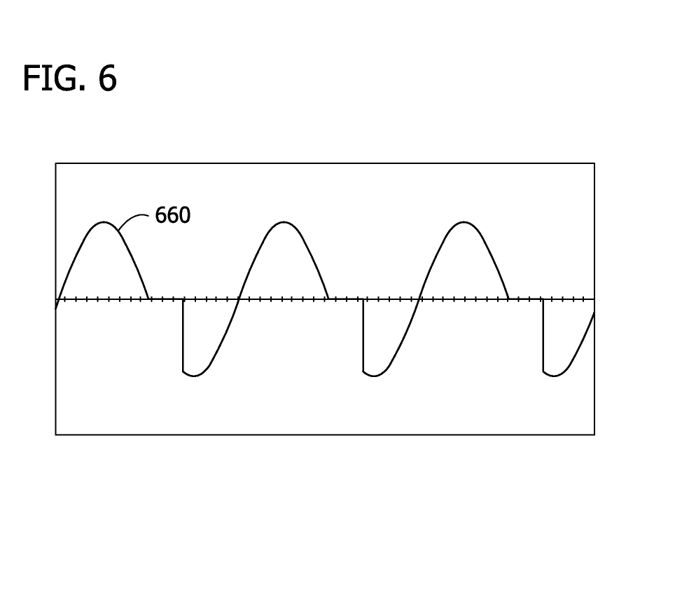

When the first lamp input terminal 304 and the second lamp input terminal 306 are both simultaneously connected to the power source, the voltage conversion circuit 314 simultaneously receives the first input voltage waveform 450 (see FIG. 4A) and the second input voltage waveform 550 (see FIG. 5A). The diode D1 half-wave rectifies the first input voltage waveform 450 to generate the first load voltage waveform 460 (see FIG. 4B), and the SIDAC Z1 voltage clips the second input voltage waveform 550 to generate the second load voltage waveform 560 (see FIG. 5B). As such, the voltage conversion circuit 314 generates a third load voltage waveform which is the combination of the first load voltage waveform 460 and the second load voltage waveform 560. FIG. 6 illustrates an exemplary third load voltage waveform 660 which is generated when the first load voltage waveform 460 illustrated in FIG. 4B is combined with the second load voltage waveform 560 illustrated in FIG. 5B. The exemplary third load voltage waveform 660 has an RMS voltage (e.g., “third RMS load voltage”) of about 110 Volts. The single filament 312 is then energized as a function of the third load voltage waveform 660, and, the single filament 312 produces a third light level that corresponds to the third RMS load voltage. Since the third RMS load voltage is greater than the first and second RMS voltages, the third light level is brighter (e.g., greater light intensity, more lumens) than both the first and second light levels.

Thus, in accordance with the illustrated embodiment, a 3-way halogen lamp having a single filament 312 is able to selectively generate a first light level, a second light level, and a third light level. For example, the first light level may be a low light level (e.g., marketed as 47 Watts/630 lumens), the second light level may be a mid light level (e.g., 62 W/1100 lumens), and the third light level may be a high light level (e.g., marketed as 72 Watts/1500 lumens). The first light level is selected by connecting only the first lamp input terminal 304 of the first and second lamp input terminals 304, 306 with the power source. The second light level is selected by connecting only the second lamp input terminal 306 of the first and second lamp input terminals 304, 306 with the power source. And, the third light level is selected by simultaneously connecting both the first lamp input terminal 304 and the second lamp input terminal 306 with the power source.

It is contemplated that there could be other configurations that realize the multi-level lighting functions noted above. For example, the first terminal may be connected to the switching circuit 322, and the second terminal may be connected to the rectifier.

The order of execution or performance of the operations in embodiments illustrated and described herein is not essential, unless otherwise specified. The operations may be performed in any order, unless otherwise specified, and embodiments may include additional or fewer operations than those disclosed herein. For example, it is contemplated that executing or performing a particular operation before, contemporaneously with, or after another operation is within the scope of aspects of the embodiments.

When introducing elements, the articles “a,” “an,” “the,” and “said” are intended to mean that there are one or more of the elements. The terms “comprising,” “including,” and “having” are intended to be inclusive and mean that there may be additional elements other than the listed elements.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively or in addition, a component may be implemented by several components.

The above description illustrates by way of example and not by way of limitation. This description enables one skilled in the art to make and use the disclosure, and describes several embodiments, adaptations, variations, alternatives and uses, including what is presently believed to be the best mode of carrying out the disclosure. Additionally, it is to be understood that the disclosure is not limited in its application to the details of construction and the arrangement of components set forth in the following description or illustrated in the drawings. The disclosure is capable of other embodiments and of being practiced or carried out in various ways. In addition, it will be understood that the phraseology and terminology used herein is for the purpose of description and should not be regarded as limiting.

Having described aspects in detail, it will be apparent that modifications and variations are possible without departing from the scope of aspects as defined in the appended claims. As various changes could be made in the above constructions, products, and methods without departing from the scope thereof, all matter contained in the above description and accompanying drawings shall be interpreted as illustrative and not in a limiting sense.

Glossary: A non-limiting list of the above reference numerals:
100 lamp
102 lamp base
104 first lamp input terminal
106 second lamp input terminal
108A, 108B third lamp input terminal
110 halogen capsule
112 filament
114 voltage conversion circuit
200 lamp
202 lamp base
204 first lamp input terminal
206 second lamp input terminal
208A, 208B third lamp input terminal
210 halogen capsule
212 filament
214 voltage conversion circuit
304 first lamp input terminal
306 second lamp input terminal
308 third lamp input terminal
312 filament
314 voltage conversion circuit
320 rectifier circuit
322 switching circuit
D1 diode
Z1 silicon diode for alternating current
450 first input voltage waveform
460 first load voltage waveform
550 second input voltage waveform
560 second load voltage waveform
660 third load voltage waveform

We claim:

1. A lamp (100; 200) for selectively generating at least a first light level, a second light level, and a third light level, the lamp (100; 200) comprising:
a base (102; 202) having a first lamp terminal (104; 204; 304) and a second lamp terminal (106; 206; 306) that are each configured for selectively connecting to a power source, wherein the first lamp terminal (104; 204; 304) receives a first input voltage waveform (450) from the power source when the first lamp terminal (104; 204; 304) is connected to the power source, wherein the second lamp terminal (106; 206; 306) receives a second input voltage waveform (550) from the power source when the second lamp terminal (106; 206; 306) is connected to the power source;
a rectifier circuit (320) connected to the first lamp terminal (104; 204; 304) for receiving the first input voltage waveform (450) from the first lamp terminal (104; 204; 304) and rectifying the first input voltage waveform (450) to generate a first load voltage waveform (460), the first load voltage waveform (460) having a first root mean square (RMS) voltage;
a switching circuit (322) connected to the second lamp terminal (106; 206; 306) for receiving the second input voltage waveform (550) from the second lamp terminal (106; 206; 306) and phase clipping the second input voltage waveform (550) to generate a second load voltage waveform (560), the second load voltage waveform (560) having a second RMS voltage;
a halogen capsule (110; 210) attached to the base (102; 202); and
a single filament (112; 212; 312) connected to the rectifier circuit (320) and the switching circuit (322), the single filament (112; 212; 312) housed in the halogen capsule (110; 210);
wherein the single filament (112; 212; 312) receives only the first load voltage waveform (460) of the first and second load voltage waveforms (460, 560) and generates the first light level therefrom when only the first lamp terminal (104; 204; 304) of the first and second lamp terminals (104, 204; 106, 206; 304, 306) is connected to the power source,
wherein the single filament (112; 212; 312) receives only the second load voltage waveform (560) of the first and second load voltage waveforms (460, 560) and generates the second light level therefrom when only the second lamp terminal (106; 206; 306) of the first and second lamp terminals (104, 204; 106, 206; 304, 306) is connected to the power source, and
wherein the single filament (112; 212; 312) receives both the first load voltage waveform (460) and the second load voltage waveform (560) and generates the third light level therefrom when the first and second lamp terminals (104, 204; 106, 206; 304, 306) are simultaneously connected to the power source.

2. The lamp (100; 200) of claim 1 wherein the rectifier circuit (320) comprises a diode (D1) having an anode and a cathode, wherein the anode is connected to the first lamp terminal (104, 204; 304) and the cathode is connected to the single filament (112; 212; 312).

3. The lamp (100; 200) of claim 1 wherein the switching circuit (322) comprises a silicon diode for alternating current (SIDAC) (Z1).

4. The lamp (100; 200) of claim 1 wherein the second RMS voltage is greater than the first RMS voltage.

5. The lamp (100; 200) of claim 1 wherein the first lamp terminal (104; 204; 304) is a base ring terminal and the second lamp terminal (106; 206; 306) is a base eyelet terminal.

6. The lamp (100; 200) of claim 1 wherein the first light level is a low light level, the second light level is a mid light level, and the third light level is a high light level.

7. The lamp (100; 200) of claim 1 wherein the rectifier circuit (320) half-wave rectifies the first input voltage waveform (450) to generate the first load voltage waveform (460).

8. The lamp (100; 200) of claim 1 wherein the first RMS voltage of the first load voltage waveform (460) is about 84 Volts.

9. The lamp (100; 200) of claim 1 wherein the second RMS voltage of the second load voltage waveform (560) is about 100 Volts.

10. The lamp (100; 200) of claim 1 wherein the single filament (112; 212; 312) generates the third light level from a third load voltage waveform (660), the third load voltage waveform is the first load voltage waveform (460) combined with the second load voltage waveform (560), wherein the third load voltage waveform (660) has a third RMS voltage.

11. The lamp (100; 200) of claim 10 wherein the third RMS voltage is about 110 Volts.

12. The lamp (100; 200) of claim 1 wherein the single filament (112; 212; 312) is connected in series with the rectifier circuit (320) and with the switching circuit (322).

13. The lamp (100; 200) of claim 1 wherein the first light level produces about 630 lumens, the second light level produces about 1100 lumens, and the third light level produces about 1500 lumens.
